(19) United States
(12) Patent Application Publication
(10) Pub. No.: US 2026/0168927 A1
(43) Pub. Date: Jun. 18, 2026

(54) Differentiable end-to-End Pixel-Super-Resolution Lensless Imaging

(71) Applicant: The University of Hong Kong, Hong Kong (CN)

(72) Inventors: Ni Chen, Xi'An (CN); Yin Mun Edmund Lam, Hong Kong (CN)

(73) Assignee: The University of Hong Kong, Hong Kong (CN)

(21) Appl. No.: 19/418,648

(22) Filed: Dec. 12, 2025

Related U.S. Application Data
(60) Provisional application No. 63/734,528, filed on Dec. 16, 2024.

(51) Int. Cl. G01N 21/47; G01N 21/17; G03H 1/00; G03H 1/04

(52) U.S. Cl. CPC G01N 21/4788; G03H 1/0005; G03H 1/0443; G01N 2021/1772; G01N 2201/0626; G01N 2201/103; G03H 2001/005; G03H 2001/045

(57) ABSTRACT

A differentiable Pixel-Super-Resolution (dPSR) lensless imaging system includes a light source, a sensor positioned to receive a beam of light from it to form a holographic image thereof. A platform for a sample is located between the light source and the sensor so the sensor receives light that has passed through a sample on the platform in the form of a series of images of the sample at a series of angles. A computer accepts the series of images from the sensor and reconstructs a full image of the target at a higher resolution than the sensor, by integrating differentiable PSR image hologram synthesis, autofocusing, and complex-field sample reconstruction with an inverse problem-solving algorithm into a single unified end-to-end framework. The automatic differentiation causes simultaneous reconstruction of (a) the complex field representing the sample, (b) the subpixel-shift scanning positions, and (c) the sample-to-sensor distance using gradient descent optimization.

### CROSS REFERENCE TO RELATED APPLICATION

The present application claims the benefit of U.S. patent application Ser. No. 63/734,528, filed Dec. 16, 2024, which is hereby incorporated by reference in its entirety.

### FIELD OF THE INVENTION

The present invention relates to computational and lensless imaging and, more particularly, to a differentiable framework for lensless systems that jointly reconstructs a complex optical field.

### BACKGROUND OF THE INVENTION

Lensless imaging in general utilizes a minimal optical setup, comprising a light source and a sensor positioned at a significant distance, with the sample placed close to the sensor [1], as shown in FIG. 1. This configuration achieves an impressive numerical aperture (NA) nearing 1, enabling microscopic resolution with pixel-sized features across a wide field of view (FOV). However, despite the capabilities of modern high-megapixel sensors, lensless imaging systems often do not attain their maximum diffraction-limited resolution, primarily due to the use of micrometer-sized pixels.

Techniques like pixel super-resolution (PSR) have become essential to address the limitations caused by the use of micrometer-sized pixels [2, 3]. By eliminating traditional lenses and employing computational imaging, lensless systems provide high-resolution imaging in a compact and cost-effective manner. The simplicity and adaptability of lensless optics are expanding its applications in high-resolution imaging, making it increasingly popular within the scientific community. This versatility has led to numerous applications across various fields, including medical imaging of cells and tissues [4], protein crystallography [5], microbial monitoring [6], and environmental sensing [7]. PSR has particularly emerged as a powerful technique for high-resolution, label-free cell imaging, offering notable advantages in terms of cost and system simplicity. Despite the power of PSR techniques in lensless imaging, challenges remain that limit their applicability. These include the setup and computations required for PSR measurements, autofocusing to determine the sample-to-sensor distance, and complex field reconstruction from PSR holograms. In particular, the traditional computational reconstruction methods used in PSR face challenges due to the multiplexing needed for sub-pixel and phase-diversity measurements.

The PSR measurements are typically obtained by capturing a series of low-resolution images with sub-pixel shifts, which necessitate scanning the light source, sample or sensors. These images are then combined to synthesize a high-resolution measurement holographic image for sample reconstruction. Techniques like phase retrieval are usually conducted to reconstruct the sample from the PSR holograms [8, 9]. However, these methods require phase diversity measurements, such as multiple wave-length [10], multiple angular illumination [11-14], multiple height [15] measurements, or coded mask [11, 16] and synthetic aperture [10] techniques. These techniques add a layer of complexity to the lensless imaging system.

Furthermore, the reconstruction of the PSR holograms necessitates the accurate estimation of sample-to-sensor distances prior to applying any image reconstruction algorithms, a task that can prove to be quite challenging. Conventional autofocusing techniques typically involve backpropagating measurements to a series of distances that cover the sample locations, followed by the evaluation of the sample's focus location using a focus evaluation function [17, 18]. Various methods have been deployed to assess image focus in both the spatial and frequency domains. In the spatial domain, sharp edges are characteristic of focused images, and operators like the Sobel operator [19], Laplace operator [20], and the total sum of gradient [17] have been employed as evaluation functions to identify focused images. In the frequency domain, focused images exhibit a higher concentration of high-frequency components compared to blurred images, making the analysis of high-frequency components, such as bandpass-filtered power spectrum analysis [20] a valuable criterion for focus evaluation. Furthermore, alternative model-based evaluation functions have emerged, including the differential critical function (DIF) [17], self-entropy [21], spectral L1 norms [22], and others. However, applying these algorithms directly to lensfree imaging presents challenges due to the presence of twin-images, which results in the merging. In particular, twin images overlay each other in the target image, which makes it difficult to recognize the target image. Additionally, factors such as lower absorption and large phase delay can further exacerbate these issues, making precise auto-focusing a formidable task. Despite some attempts, a practical and robust autofocusing method remains a pressing need for complex-field imaging [23, 24].

Finally, addressing the intricate challenge of reconstructing the complex field from PSR holograms remains a formidable inverse problem. Traditional iterative algorithms [8, 9] and optimization techniques [16, 25, 26] are often employed to solve this problem, necessitating precise autofocusing to ensure the accuracy of the imaging model. It's evident that there exists a mutual constraint between autofocusing and complex field reconstruction. However, conventional methods typically adopt a sequential approach to estimate the PSR hologram, autofocusing, and complex field image inversion, which is susceptible to error accumulation at each step, significantly compromising the final image quality.

PSR hologram synthesis, autofocusing, and complex field reconstruction are typically performed sequentially. Each sub-process can introduce errors that impact subsequent steps and overall imaging performance [27]. U.S. Pat. No. 8,866,063 discloses hardware systems similar to PSR using a conventional method that processes the input sequentially. This introduces errors at each stage. The system disclosed in US Application Publication 2017-0357083A1 relies on scanning light sources to introduce sub-pixel shifts for synthesizing pixel-super-resolution holograms and multiple sample-to-sensor distances for phase retrieval during image reconstruction. This has the micrometer-sized pixel problem.

### SUMMARY OF THE INVENTION

The present invention provides a differentiable lensless imaging system and method that integrate hologram synthesis, focusing, and phase retrieval into a single differentiable optimization. The system comprises: (1) a light-source assembly (either an array or a scanning source) configured to illuminate a sample from multiple lateral positions; (2) an image sensor configured to record corresponding diffraction patterns; and (3) a processor executing a differentiable forward model of light propagation between the sample and sensor. Sub-pixel shift diversity required for high-resolution reconstruction may be achieved by translating the light source, the sensor, or the sample, individually or in combination.

Through automatic differentiation, the processor jointly estimates the complex optical field, relative translation parameters, and the sample-to-sensor distance by minimizing a differentiable loss function that combines intensity fidelity with one or more flexible regularization terms. This approach eliminates explicit phase diversity, achieves sub-pixel registration and micrometer-scale focusing precision, and enables resolution enhancement beyond the sensor's native pixel pitch, while maintaining simple lens-free hardware.

In an exemplary embodiment, to address the challenges of prior art systems, the present invention, rather than using sequential steps, uses a differentiable end-to-end PSR (dPSR) lensless imaging technique that integrates PSR image hologram synthesis, autofocusing, and complex-field sample reconstruction into a single unified process that represents the numerical forward model of the lensless system. Further, the differentiable framework that models physical uncertainties integrates an inverse problem-solving algorithm for lensless holographic imaging, i.e., the reconstruction of the complex field from PSR holograms.

By leveraging automatic differentiation, simultaneous reconstruction of (a) the complex field representing the sample, (b) the subpixel shift scanning positions, and (c) the sample-to-sensor distance using gradient descent optimization are achieved. In effect, key system parameters, including scanning locations and sample-to-sensor distances, are modeled as variables within differentiable functions This numerical model, which accounts for unknown scanning positions and the sample-to-sensor distance, provides a more accurate representation of the real imaging system, eliminating the need for phase diversity measurements such as multi-depth, multi-wavelength, or multi-angle scanning. This joint optimization of multiple variables reduces error accumulation associated with sequential processing. Together, these advances offer a simple, cost-effective, and high-performance solution for lensless imaging, broadening the applicability of pixel super-resolution in biomedical and scientific imaging applications

The integrated system of the present invention is a significant departure from conventional sequential processing methods and offers several key advantages:
1. Enhanced Accuracy: By eliminating the error accumulation inherent in sequential processing, the unified approach of the present invention achieves more precise reconstructions while maintaining system simplicity.
2. Simplified Data Collection: The end-to-end optimization enables more accurate numerical modeling, effectively eliminating the need for complex phase diversity measurements (such as multi-depth, multi-wavelength, or multi-angle scanning).
3. Improved Resolution: Experimental results demonstrate a remarkable two-fold improvement in resolution compared to the sensor's pixel size, validating the effectiveness of the invention.

Together, these advances offer a simple, cost-effective, and high-performance solution for lensless imaging, broadening the applicability of pixel super-resolution in biomedical and scientific imaging applications. Furthermore, the objective function is designed with domain-specific priors to address noisy data while preserving high-resolution PSR holograms. In particular, the L1 norm is used to ensure sparsity and the total variation (TV) norm is used to deal with noise data. Besides, the Laplacian operator is applied to holograms to maintain high-resolution details.

The invention achieves a two-fold resolution improvement over the pixel-size of the sensor, demonstrating its effectiveness in high-resolution lensless imaging. Thus, the present invention provides simple, affordable, and high-performance solutions. This invention addresses physical variances in lensless imaging, including uncertainties in scanning positions and target sample locations.

### BRIEF DESCRIPTION OF THE DRAWINGS

The foregoing and other objects and advantages of the present invention will become more apparent when considered in connection with the following detailed description and appended drawings in which like designations denote like elements in the various views, and wherein:

FIG. 1A is a lensless setup for pixel-super-resolution (PSR) imaging where a laser light source is moved during a series of iterations and FIG. 1B is a setup for PSR imaging where an LED array is used as the light source;

FIG. 2A is an image of pieces of material used in a simulation for numerical experiments to analyze errors in autofocusing with the present invention, FIG. 2B shows graphs of the autofocus performance with the Laplacian metric for an absorption-only sample, FIG. 2C shows graphs of the autofocus performance with the Laplacian metric for phase-only samples, FIG. 2D shows graphs of the autofocus performance with the Laplacian metric for a sample with both absorption and phase delay, and FIG. 2E shows how closely the cross-correlation method estimates position with respect to 25 randomly generated scanning positions for a sensor;

FIG. 3A shows raw data from imaging a USAF resolution chart with an enlarged view of a center section (small box in the center) located in the lower left corner, FIG. 3B shows the reconstruction of the center patch, FIG. 3C compares scanning positions estimated by cross-correlation and differentiable Pixel-Super-Resolution (dPSR) methods of the present invention which have superior accuracy and FIG. 3D demonstrates accurate sample-to-sensor distance estimation by the dPSR method; and

FIG. 4A shows the raw data from an experiment with oral cells, FIG. 4B is an enlarged view of the portion in the square at the bottom left corner of FIG. 4A and FIG. 4C is an enlarged view of the center section of FIG. 4B. ***

### DETAILED DESCRIPTION OF THE INVENTION

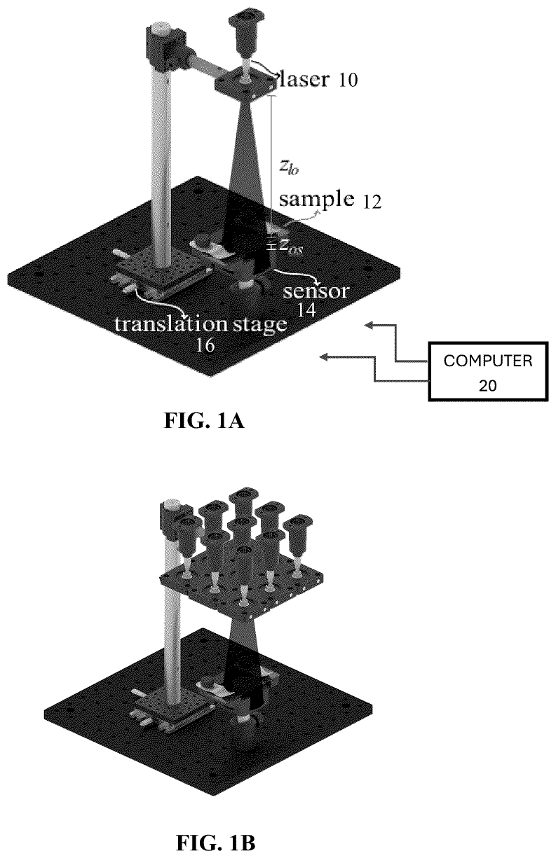

To achieve PSR, the light scanning method as schematically shown in FIG. 1 is adopted. The laser light source (laser 10) is mounted on a x-y translation stage 16, which is controlled by a computer 20. The distance between the light source and a sample object 12 is Zₗₒ, and the distance between the sample object 12 and a camera sensor 14 is Zₒₛ, while Zₗₒ>>Zₒₛ. The laser light source 10 is scanned translationally, where the location doesn't need to be provided. The translation stage 16 and the camera sensor 14 are synchronized by the computer 20 using Python code. The sensor camera captures the intensity of the light that passes through the sample at each scanning position. The scanning light source could also be replaced by a light source array, e.g., a two-dimensional LED array, for more robust scanning. FIG. 1B

In order to create a mathematical model for PSR lensless imaging the forward process of lensless pixel super-resolution imaging is represented as a function that depends on three key factors: 1) the high-resolution complex field of the target sample, denoted as u; 2) the distance between the sample and the camera sensor, denoted as z, and 3) the scanning location of the n-th measurement, denoted as rₙ, where rₙ=(xₙ, yₙ). The n-th image captured by the camera sensor can be expressed as:

$${y}_{n} = f ( u ( {r}_{n} , z ) = {𝒮}_{down} {\vert 𝒫 ( u ( {r}_{n} ) , z ) \vert}^{2} , \qquad ( 1 )$$

where P(⋅) characterizes the wave propagation, and Sdown is responsible for the down-sampling of camera sensor pixels [15, 16]. The wave propagation function P(⋅) is determined by the convolution of u(r, z) with the free-space point spread function implemented with the angular spectrum method (ASM) [28]. Taking the first measurement y₀ as the reference, the n-th measurement yₙ can be expressed as translating the first measurement by rₗₗ−r₀. The translation operation can be expressed using the following expression:

$$u ( {r}_{n} ) = {F}^{- 1} \{ F \{ u ( {r}_{1} ) \} \times exp [ j 2 π ( {r}_{n} - {r}_{1} ) f r ] \} \qquad ( 2 )$$

Here, fᵣ represent the frequency coordinates along the x and y axes, and F and F⁻¹ denote the Fourier transform and its inverse, respectively. This forward model effectively simulates the translation of the sample followed by propagation to the sensor plane and down-sampling through the pixelated sensor.

To optimize differentiability, u is obtained from N measurements with unknown z and unknown scanning positions of r={r₁, . . . , r_{N}}, minimizing an error metric defined as

$$ℒ ( u , z , r ) = \frac{1}{N} {\sum }_{n = 1}^{N} {‖ f ( u ( {r}_{n} , z ) - {y}_{n} ‖}^{2} + {β}_{0} \frac{1}{{N}_{x} {N}_{y}} \sum \vert {∇}^{2} {\vert 𝒫 ( u ( {r}_{1} ) , z \vert}^{2} \vert + {β}_{1} {ℝ}_{{ℓ}_{1}} ( u ( {r}_{1} ) ) + {β}_{2} {ℝ}_{TV} ( u ( {r}_{1} ) ) \qquad ( 3 )$$

where N is the number of measurements, r={r₁, . . . , r_{N}} is the set of scanning positions. The data fidelity term

$$\frac{1}{N} {\sum }_{n = 1}^{N} {\vert f ( u ( {r}_{n} ) , , z ) - {y}_{n} \vert}^{2}$$

ensures the reconstructed image matches the measured data. The second term

$${β}_{0} \frac{1}{{N}_{x} {N}_{y}} \sum \vert {∇}^{2} {\vert 𝒫 ( u ( {r}_{1} ) , , z \vert}^{2} \vert$$

enhances high-resolution features of the hologram by incorporating second-order spatial derivatives. The lᵢ norm Rₗ_{ᵢ}(⋅) promotes sparsity, which aids in autofocusing since focused samples typically have sparse representations. The total variation (TV) norm R_{TV}(⋅) helps suppress experimental noise. Due to the model's non-linearity and non-convexity, finding a solution to the inverse problem is challenging. However, since the forward model defined in Eq. (1) is differentiable with respect to the parameters {u, z, r}, the optimization problem in Eq. (3) can be solved using gradient descent as detailed in Algorithm 1.

In imaging, “differentiable” means that an image representation or manipulation process can be mathematically differentiated, allowing for the calculation of gradients which are crucial for optimization techniques like gradient descent, essentially enabling fine-tuning of an image by making small adjustments based on how changes in pixel values affect the desired outcome within a neural network or computational imaging pipeline. Differentiable holography addresses the mismatches between numerical models and real-world scenarios by incorporating system imperfections into the imaging model and leveraging differentiable optimization techniques to overcome the complex inversion of the forward model, demonstrating its effectiveness across various applications. In particular, differentiable holography is capable of reconstructing complex fields from a single-shot inline hologram, achieving high-performance PSR lensless holographic imaging without additional phase retrieval measures, and resolving denser volumetric particle imaging.”

In carrying out Algorithm 1 all parameters of the model are optimized jointly using gradient descent. In each iteration, the gradient of the loss function is computed through automatic differentiation, and the parameters are updated accordingly. The forward model of the imaging system, influenced by both the sample-to-sensor distance z and the scanning position r, is also updated at every iteration.

Algorithm 1. Diferentiable lensless PSR solver.

function RECONSTRUCT SAMPLE AND SYSTEM PARAMETERS( [symbol] )

| | |
|---|---|
| Initialize {u⁰, z⁰, r⁰}; | [symbol] Initialization |
| f⁰ ← f( [symbol] z⁰, r⁰); | [symbol] Initialization of the forward imaging model |
| while not converged do | [symbol] Iteration |
| ${u}^{k + 1} , {z}^{k + 1} , {r}^{k + 1} ← \begin{matrix}arg min \\ u , z , \text{?}\end{matrix} ℒ ( {u}^{k} , {z}^{k} , {r}^{k} ) ;$ | [symbol] update with automatic differentiation |
| f^{k+1} ← f( [symbol] , z^{j+1}, r^{k+1}); | [symbol] Imaging model update |
| return {u^{K}, z^{K}, r^{K}}; | [symbol] At final iteration K |

[symbol]

indicates data missing or illegible when filed

This optimization process continues until convergence is achieved. Unlike traditional methods, the PSR hologram is not explicitly acquired, and there is no separate autofocusing step. Instead, the high-resolution image is generated by optimizing the defined error metric in Eq. (1) in an end-to-end manner. This approach eliminates the issue of error accumulation that often affects sequential steps in conventional techniques. Algorithm 1 is implemented using PyTorch on computer 20.

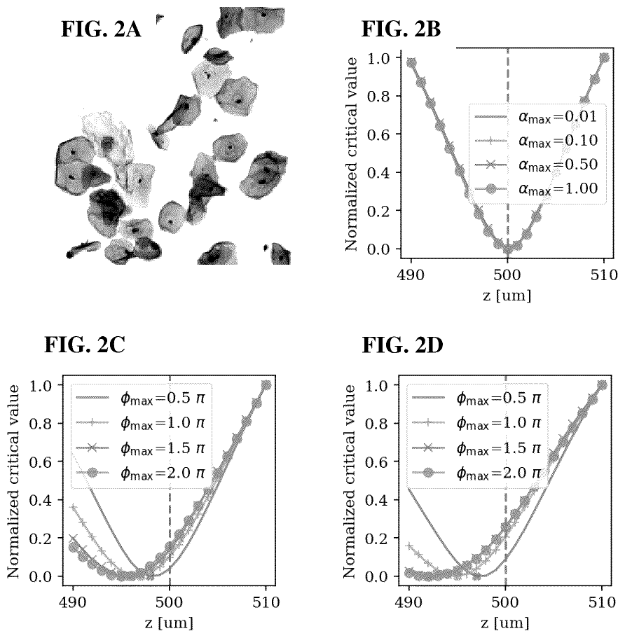

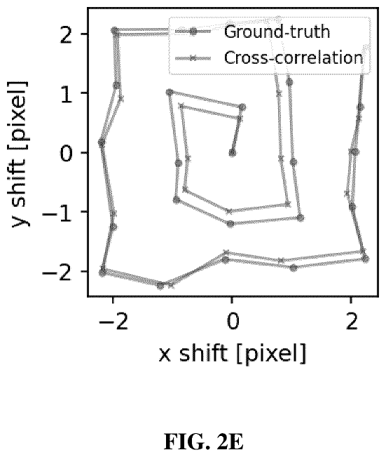

To show the challenges of autofocusing for lensless imaging, numerical analysis is performed. To mimic the reliability, the transmission function of the object is defined as tₒ=exp (−αmax I)×exp [jφₘₐₓ I], where I is a gray image normalized to a range from 0 to 1, αₘₐₓ represents the maximum absorption rate, and φₘₐₓ signifies the maximum phase delay induced by the sample. The test image is depicted in FIG. 2A.

In this measurement, the light source has a wavelength of 405 nm, and both the sample and sensor camera feature a pixel size of 1.1 μm with a pixel count of 512×512. The distance between the sample and the sensor was set to 500 nm. Autofocusing was performed using the established Laplacian method [29], with backpropagation distances ranging from 490 nm to 510 nm, encompassing the sample's position at 500 nm. As shown in FIG. 2B, the detected sample position remains accurate regardless of the absorption rate for absorption-only samples. However, FIG. 2C illustrates that the detected sample location becomes increasingly inaccurate for phase delay φₘₐₓ-only samples, with greater inaccuracies observed as the phase delay increases from 0.5π to 2.07π. In FIG. 2D, autofocusing performance is shown for a sample with both absorption and phase delay, where the absorption is set to 0.1 to model a label-free cell with low absorption. The detected location is less accurate compared to the phase-only sample in FIG. 2C.

For inline hologram autofocusing, the twin-image problem complicates the differentiation between sharp and defocused images, where the conjugated reconstruction of the target acts as noise in the reconstruction. While higher absorption results in clearer amplitude distributions with sharper edges, aiding autofocus, phase-dominated samples tend to have less distinct edges, making accurate focusing difficult, especially when the phase range is large. For the position estimation, 25 scanning positions were randomly generated for the sensor, indicated by dots (ground truth positions) in FIG. 2E. The “x”s represent the estimated positions using the cross-correlation method. The mean absolute position estimation error was found to be 0.1172 pixels, which is rather large for the precision required in PSR hologram synthesis. This analysis underscores the challenges involved in scanning position estimation and autofocusing in lensless imaging, highlighting the need for more robust and precise methods.

In the experimental setup, a monochromatic CMOS sensor (Jiangsu Team One Intelligent Technology Co., Ltd.) with a pixel size of 0.9 μm and a resolution of 5664×4256 pixels was used, providing a field of view (FOV) of 5.1 mm×3.8 mm. The light source was a Thorlabs LP405C1 laser diode with a collimator output, emitting at a central wavelength of 405 nm. The sensor was positioned very close to the sample, at a distance of less than 1 mm, while the light source was placed approximately 15 cm away from the sample.

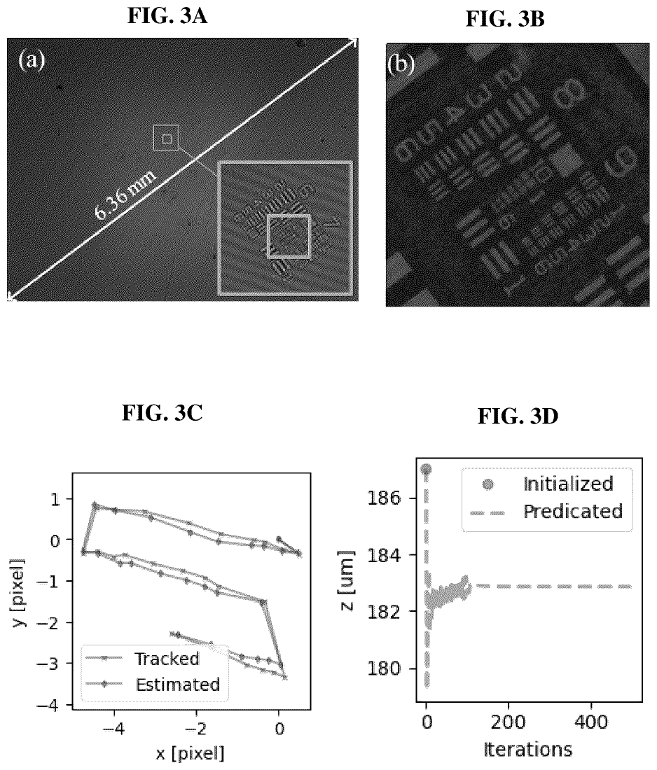

The resolution performance of the setup was evaluated using a phase-only USAF Resolution target from Benchmark Optics by capturing image sequences at different light source positions. In FIG. 3A raw images from a 25-image stack of the USAF resolution chart are shown with an enlarged view of a center section (small box in the center) located in the lower left corner. Reconstructed images of the center section of FIG. 3A are shown in FIG. 3B. The differentiable Pixel-Super-Resolution (dPSR) method of the present invention achieved a resolution of 435 nm (group 10, element 2), representing a 2.0-fold improvement over the sensor's pixel size. FIG. 3C compares scanning positions estimated by cross-correlation and dPSR methods, with dPSR, showing superior accuracy. Similarly, FIG. 3D demonstrates accurate sample-to-sensor distance estimation by dPSR. These results validate dPSR's effectiveness in both position estimation and resolution enhancement for lensless imaging.

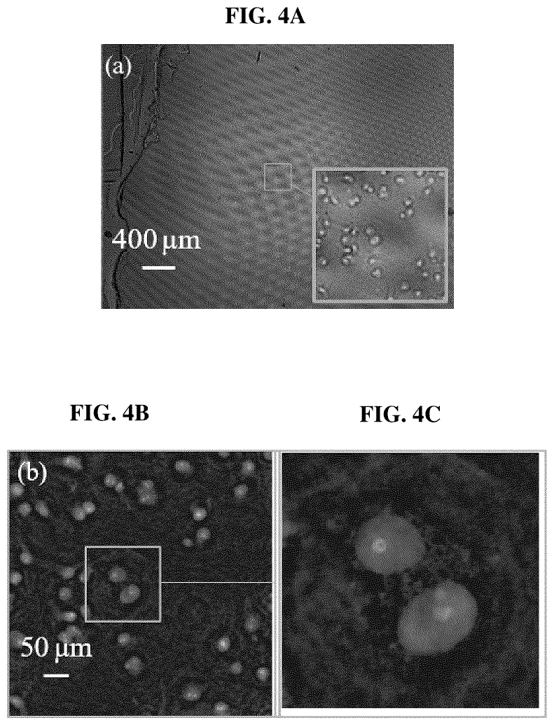

The sub-micrometer resolution capabilities of the present invention are demonstrated by imaging label-free COS7 cells. FIG. 4A shows the unprocessed raw image, while FIG. 4B presents the re construction from the 25 images of the scan. The enlarged reconstructed image of FIG. 4C clearly reveals cell nuclei, demonstrating the system's ability to capture key cellular structures without labels. This capability enables non-invasive cellular analysis and opens new possibilities for live cell imaging studies.

Thus, the present invention is a differentiable end-to-end PSR lensless imaging technique that integrates hologram synthesis, autofocusing, and inverse image reconstruction into a unified framework. This approach achieves high-resolution imaging with minimal measurements and eliminates the need for phase diversity in phase retrieval. The joint optimization of scanning positions, sample-to-sensor distance, and sample reconstruction enables flexible scanning strategies. This framework can potentially accommodate full 3D scanning movements, which may further enhance measurement diversity and imaging performance.

The above are only specific implementations of the invention and are not intended to limit the scope of protection of the invention. Any modifications or substitutes apparent to those skilled in the art shall fall within the scope of protection of the invention. Therefore, the protected scope of the invention shall be subject to the scope of protection of the claims.

### REFERENCES

The cited references in this application are incorporated herein by reference in their entirety and are as follows:
[1.]E. McLeod and A. Ozcan, “Microscopy without lenses,” Phys. Today 70, 50-56 (2017).
[2]W. Bishara, T.-W. Su, A. F. Coskun, and A. Ozcan, “Lensfree on-chip microscopy over a wide field-of-view using pixel super-resolution,” Opt. Express 18, 11181 (2010).
[3]A. Greenbaum and A. Ozcan, “Maskless imaging of dense samples using pixel super-resolution based multi-height lensfree on-chip microscopy,” Opt. Express 20, 3129 (2012).
[4]C. J. Potter, Y Hu, Z. Xiong, et al., “Point-of-care SARS-CoV-2 sensing using lens-free imaging and a deep learning-assisted quantitative agglutination assay,” Lab on Chip 22, 3744-3754 (2022).
[5]M. U. Daloglu, A. Ray, M. J. Collazo, et al., “Low-cost and portable UV holographic microscope for high-contrast protein crystal imaging,” APL Photonics 4 (2019).
[6]S. Jiang, C. Guo, Z. Bian, et al., “Ptychographic sensor for large-scale lensless microbial monitoring with high spatiotemporal resolution,” Biosensors and Bioelectronics. 196, 113699 (2022).
[7]Y Wu and A. Ozcan, “Lensless digital holographic microscopy and its applications in biomedicine and environmental monitoring,” Methods 136, 4-16 (2018).
[8]R. W. Gerchberg, “A practical algorithm for the determination of phase from image and diffraction plane pictures,” Optik 35, 237-246 (1972).
[9]J. R. Fienup, “Phase retrieval algorithms: a comparison,” Appl. Opt. 21, 2758 (1982).
[10]W. Luo, Y Zhang, A. Feizi, et al., “Pixel super-resolution using wave-length scanning,” Light. Sci. Appl. 5, e16060 (2015).
[11]Z. Zhang, Y Zhou, S. Jiang, et al., “Invited article: Mask-modulated lensless imaging with multi-angle illuminations,” APL Photonics 3, 060803 (2018).
[12]T.-W. Su, S. O. Isikman, W. Bishara, et al., “Multi-angle lensless digital holography for depth resolved imaging on a chip,” Opt. Express 18, 9690 (2010).
[13]Y Guo, R. Guo, P. Qi, et al., “Robust multi-angle structured illumination lensless microscopy via illumination angle calibration,” Opt. Lett. 47, 1847 (2022).
[14]. Zhou, J. Wu, J. Suo, et al., “Single shot lensless imaging via simultaneous multi-angle LED illumination,” Opt. Express 26, 21418 (2018).
[15]J. Zhang, J. Sun, Q. Chen, and C. Zuo, “Resolution analysis in a lens-free on-chip digital holographic microscope,” IEEE Trans. on Comput. Imaging 6, 697-710 (2020).
[16]Y Gao and L. Cao, “Generalized optimization framework for pixel super-resolution imaging in digital holography,” Opt. Express 29, 28805 (2021).
[17]M. Lyu, C. Yuan, D. Li, and G. Situ, “Fast autofocusing in digital holography using the magnitude differential,” Appl. Opt. 56, F152 (2017).
[18]Z. Ren, N. Chen, and E. Y Lam, “Automatic focusing for multisectional objects in digital holography using the structure tensor,” Opt. Lett. 42, 1720 (2017).
[19]F. Dubois, C. Schockaert, N. Callens, and C. Yourassowsky, “Focus plane detection criteria in digital holography microscopy by amplitude analysis,” Opt. Express 14, 5895 (2006).
[20]P. Langehanenberg, B. Kemper, D. Dirksen, and G. von Bally, “Autofocusing in digital holographic phase contrast microscopy on pure phase objects for live cell imaging,” Appl. Opt. 47, D176 (2008).
[21]J. Gillespie and R. King, “The use of self-entropy as a focus measure in digital holography,” Pattern Recognit. Lett. 9, 19-25 (1989).
[22]W. Li, N. C. Loomis, Q. Hu, and C. S. Davis, “Focus detection from digital in-line holograms based on spectral l₁ norms,” J. Opt. Soc. Am. A 24, 3054 (2007).
[23]M. Trusiak, J.-A. Picazo-Bueno, P. Zdankowski, and V. Micó, “DarkFocus. numerical autofocusing in digital in-line holographic microscopy using variance of computational dark-field gradient,” Opt. Lasers Eng. 134, 106195 (2020).
[24]Y Wu, L. Lu, J. Zhang, et al., “Autofocusing Algorithm for pixel-super-resolved lensfree on-chip microscopy,” Front. Phys. 9 (2021)
[25]Y Gao, F. Yang, and L. Cao, “Pixel super-resolution phase retrieval for lensless on-chip microscopy via accelerated Wirtinger flow,” Cells 11, 1999 (2022)
[26]Y Gao and L. Cao, “High-fidelity pixel-super-resolved complex field reconstruction via adaptive smoothing,” Opt. Lett. 45, 6807 (2020).
[27]J. Zhang, J. Sun, Q. Chen, et al., “Adaptive pixel-super-resolved lens-free in-line digital holography for wide-field on-chip microscopy,” Sci. Reports 7 (2017).
[28]J. W. Goodman, Introduction to Fourier Optics (W.H. Freeman, Macmillan Learning, New York, 2017), fourth edition ed. Hier auch später,” erschienene, unveränderte Nachdrucke.
[29]S. Jiang, C. Guo, P. Song, et al., “Resolution-enhanced parallel coded ptychography for high-throughput optical imaging,” ACS Photonics 8, 3261-3271 (2021).

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. A differentiable Pixel-Super-Resolution (dPSR) lensless imaging system comprising:
a light source emitting a beam of light;
a sensor positioned to receive the beam of light;
a platform for a sample or target located between the light source and the sensor, where the distance between the light source and the platform is much greater than the distance between the platform and the sensor, and the sensor receives light from the light source that has passed through a sample on the platform in the form of iterations that form a series of images of the sample at a series of angles; and
a computer that accepts the series of images from the sensor and reconstructs a full holographic image of the target at a higher resolution than the sensor, by integrating differentiable PSR image hologram synthesis, autofocusing, and complex-field sample reconstruction with an inverse problem-solving algorithm into a single unified end-to-end framework representing the numerical forward model of the lensless system, whereby automatic differentiation causes simultaneous reconstruction of (a) the complex field representing the sample, (b) the subpixel shift scanning positions, and (c) the sample-to-sensor distance using gradient descent optimization.

2. The system according to claim 1 wherein all parameters are optimized jointly using gradient descent where at each iteration, the gradient of the loss function is computed through automatic differentiation, and the parameters are updated accordingly, and both the sample-to-sensor distance z and the scanning position r are also updated at every iteration.

3. The system of claim 1 wherein the autofocusing is achieved using the established Laplacian method.

4. The system of claim 1 wherein the light source is a laser mounted on an x-y translation stage controlled by the computer so as translationally scan the sample to present the iteration in the form of a series of images of the sample at the series of angles to the sensor, the sensor captures the intensity of the light that passes through the sample at each scanning position and wherein translation stage and the sensor are synchronized by the computer.

5. The system of claim 1 wherein the light source is a two-dimensional array of LEDs which, are variously illuminated under the control of the processor in order to present the series of images of the sample at the series of angles to the sensor.

6. The system of claim 1 wherein the sensor is a camera.

7. The system of claim 4 wherein the light source has a wavelength of 405 nm, and both the sample and sensor camera feature a pixel size of 1.1 μm with a pixel count of 512×512.

8. The system of claim 5 wherein the distance between the sample and the sensor is set to 500 nm.

9. The system of claim 6 wherein the autofocusing is performed with backpropagation distances ranging from 490 nm to 510 nm, encompassing the sample's position at 500 nm from the sensor.
